(19) United States
(12) Patent Application Publication
(10) Pub. No.: US 2006/0065649 A1
(43) Pub. Date: Mar. 30, 2006

(54) Method for remote controlled actuation of laser processing head

(76) Inventors: William G. Fredrick JR., Northville, MI (US); Richard Lee, Plymouth, MI (US); Scott Swartzinski, Plymouth, MI (US); Mike Delbusso, Farmington Hills, MI (US)

Correspondence Address: HARNESS, DICKEY & PIERCE, P.L.C., P.O. BOX 828, BLOOMFIELD HILLS, MI, 48303, US

(21) Appl. No.: 11/282,080

(22) Filed: Nov. 17, 2005

Related U.S. Application Data
(62) Division of application No. 10/791,643, filed on Mar. 2, 2004.

(51) Int. Cl. B23K 26/08

(52) U.S. Cl. 219/121.78

(57) ABSTRACT

A control system for remotely actuating a laser processing head includes a laser processing head and an actuation mechanism located remotely from the laser processing head. A translation mechanism is connected between the laser processing head and the actuation mechanism. The translation mechanism translates movement of the actuation mechanism into movement of the laser processing head. The translation mechanism includes a cable control having a first end coupled to the laser processing head and a second end coupled to the actuation mechanism. The laser processing head is slidably coupled to a robot arm. The actuation mechanism imposes relative linear motion of the laser processing head with respect to the robot arm. A height sensing system includes a height sensor for generating a height signal measurement between the laser processing head and a work-piece. A height sensor electronics module is located remotely from the height sensor and receives the height signal.

### CROSS-REFERENCE TO RELATED APPLICATIONS

This application is a divisional of U.S. patent application Ser. No. 10/791,643 filed on Mar. 2, 2004. The disclosure of the above application is incorporated herein by reference.

### FIELD OF THE INVENTION

The present invention relates to laser processing head actuation and more particularly to remote controlled actuation of a laser processing head.

### BACKGROUND OF THE INVENTION

Laser processing has become an increasingly popular method of working a piece of material especially when precise tolerances are necessary. Currently, many laser processing heads incorporate features and devices that help ensure optimal and consistent processing results. One such example is height sensing capability in laser processing heads. Out of necessity, these types of features require mechanical and electrical components that enable them to function properly. These features typically include mechanical slides, motors, encoders and electrical cabling.

These items however are built into the laser processing head in a variety of configurations for a variety of applications. A laser processing head is subjected to harsh working environments due to reflected heat, sparks from the work-piece, debris from the process (including particles, slag, fumes and smoke), dirt and contaminants on the material. Furthermore, the close proximity between the processing head and work-piece may present potential for collision.

The close proximity of these potentially sensitive components to the work-piece places these components at risk and prone to damage and failure. Moreover, by the nature of the desired compactness of a laser processing head, these components are often compromised and limited in size and performance capability.

### SUMMARY OF THE INVENTION

In an aspect of the invention, a control system for remotely actuating a tool such as a laser processing head includes a laser processing head and an actuation mechanism located remotely from the laser processing head. A translation mechanism is connected between the laser processing head and the actuation mechanism. The translation mechanism translates movement of the actuation mechanism into movement of the laser processing head.

In additional aspects of the invention, the translation mechanism includes a push/pull cable having a first end coupled to the laser processing head and a second end coupled to the actuation mechanism. The laser processing head is slidably coupled to a robot arm. The actuation mechanism imposes relative linear motion of the laser head with respect to the robot arm. A height sensing system includes a height sensor for generating a height signal based on a measurement between the laser head and a work-piece. A height sensor electronics module is located remotely from the height sensor sensing element and generates the height signal.

In further aspects of the invention, a remote control system for actuating a tool in one dimension in response to a distance measurement between the tool and a work-piece wherein the distance between the tool and the work-piece is measured by a height sensing system wherein the height sensing system is disposed at least in part in the tool includes a translation mechanism. The translation mechanism includes a first member end and a second member end wherein the first member end is coupled to the tool for actuating the tool in one dimension. The actuation mechanism is coupled to the second member end and actuates the tool. The actuation mechanism is remote to the tool and therefore not connected to the tool. A control system controls the actuation mechanism. The control system is in communication with the height sensing system and senses a distance between the tool and the work-piece. The height sensing system signals the control system to direct the actuation mechanism to actuate the tool in accordance with the distance measured by the height sensing system.

In yet additional aspects of the invention, a method for laser processing a work-piece includes providing a laser processing head wherein the laser processing head is coupled to a control system for directing movement of the laser head over the work-piece. The laser processing head comprises a sensor for measuring the distance between the laser processing head and the work-piece. The distance between the sensor and the work-piece is measured. Movement of the actuation mechanism, remotely located from the sensor, is generated based on the measured distance. The movement of the actuation mechanism is translated into linear motion of the laser processing head toward and away from the work-piece.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a system view of a remote actuated laser according to a preferred embodiment of the invention;

FIG. 2 is a perspective view of the laser processing head assembly of the preferred embodiment of the invention as shown in FIG. 1;

FIG. 3 is an exploded view of the laser head assembly of FIG. 2;

FIG. 4 is a partial cutaway view of the actuation mechanism shown communicating with the laser processing head assembly as shown in FIG. 1; and

FIG. 5 is a flowchart illustrating steps for remotely actuating the laser processing head assembly according to the preferred embodiment of the invention.

### DETAILED DESCRIPTION OF THE PREFERRED EMBODIMENTS

The following description of the preferred embodiment(s) is merely exemplary in nature and is in no way intended to limit the invention, its application, or uses. For purposes of clarity the same reference numbers will be used in the drawings to identify similar elements.

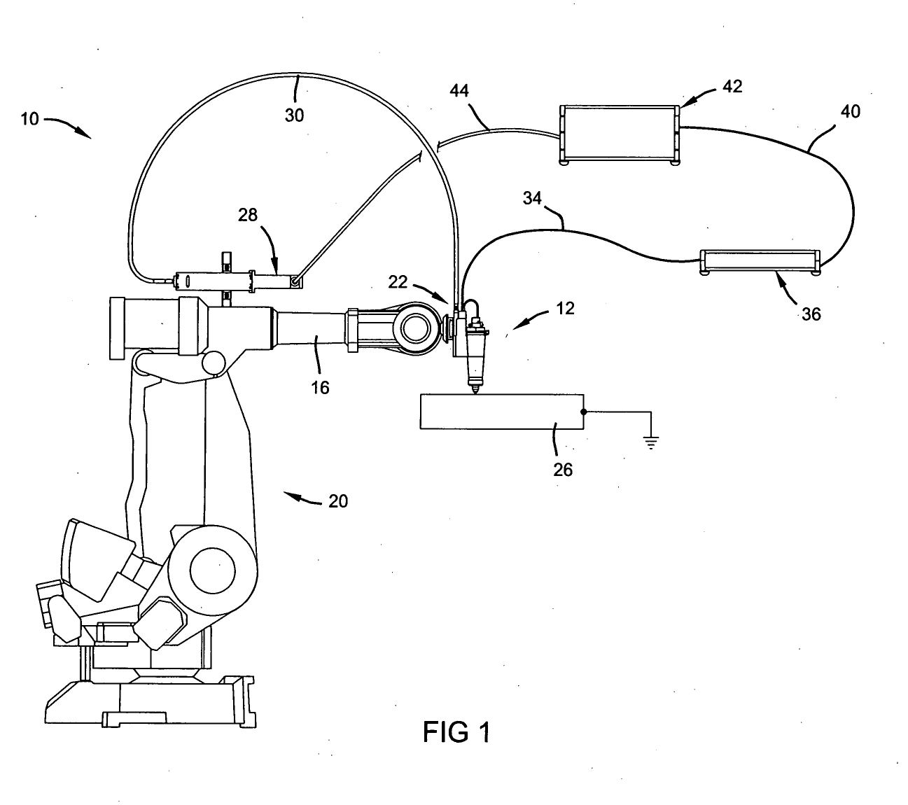

With initial reference to FIG. 1, a remote actuated laser processing system according to a preferred embodiment of the invention is shown and identified generally at reference 10. The remote actuated laser processing system 10 includes a laser processing head assembly 12 movably coupled to an arm 16 of a robot 20 through a slide mechanism 22. The laser processing head assembly 12 is configured to cut a work-piece 26 in a predetermined manner. An actuation mechanism 28 is coupled to the laser processing head assembly 12 through a translation mechanism 30. A height signal is communicated through the laser processing head assembly 12 through a first wire 34 to a height sensor electronics module 36 located remotely from the laser processing head assembly 12. The height sensor electronics module 36 communicates a signal through a second wire 40 to a motor drive electronics module 42. The motor drive electronics module 42 is located remotely from the laser head assembly and operates as a control system for controlling movement of the actuation mechanism 28. The motor drive electronics module 42 communicates a signal through a third wire 44 to the actuation mechanism 28. As will be described in greater detail, the actuation mechanism 28 moves the laser processing head assembly 12 in the vertical direction (as viewed from FIG. 1) based on a signal provided by the height sensor electronics module 36 and the motor drive electronics module 42.

The physical location of the height sensor electronics module 36, the motor drive electronics module 42 and the actuation mechanism 28 is away from the harsh environment proximate to the laser processing head assembly 12 thus reducing system vulnerability to debris and damage. Locating the actuation mechanism 28 remotely from the laser processing head assembly 12 also reduces payload and system wear as a whole. As a result, there is flexibility in choosing an actuation mechanism 28 for a given application.

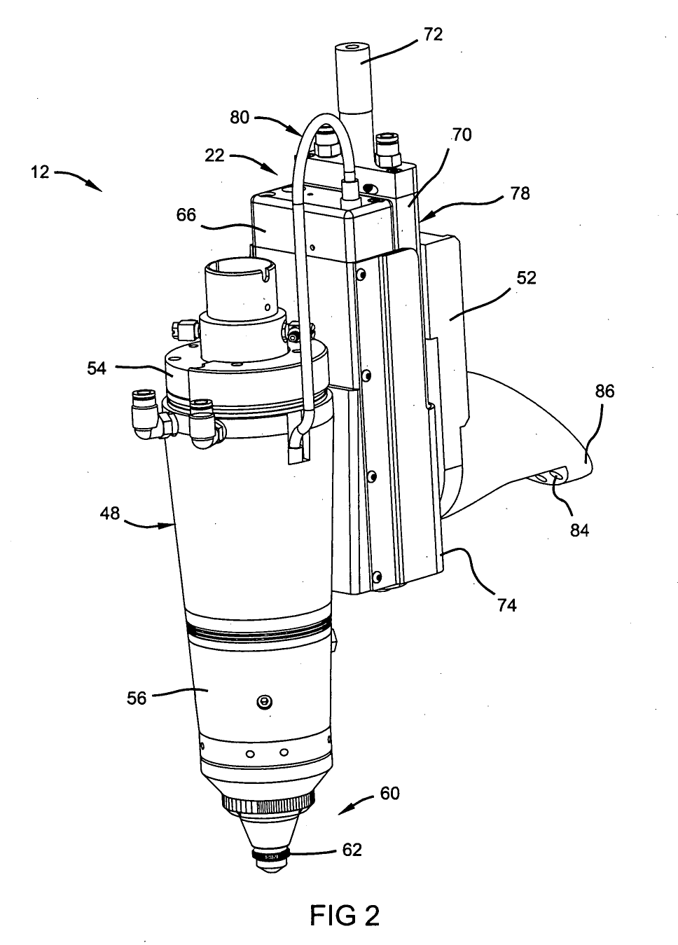

With continued reference to FIG. 1 and further reference to FIG. 2, the laser processing head assembly 12 will be described in greater detail. The laser processing head assembly 12 generally comprises a housing 48, the slide mechanism 22 and a mounting flange 52. The housing 48 includes a fiber recollimation optical component 54 for recollimating a laser beam as it exits from a fiber (not shown). The recollimation optical component 54 passes the laser beam to a lens holder 56 having a focusing optic (not specifically shown) therein. A tip assembly 60 is arranged on a distal portion of the laser housing 48 and includes a gas jet tip 62. The gas jet tip 62 serves as a sensor and provides a signal for example, a capacitive signal to the height sensor electronics module 36. The height sensor electronics module 36 interprets the signal into the height sense signal. Thus, the height sensor electronics module 36 measures the distance between the gas jet tip 62 and the work-piece 26. The tip assembly 60, first wire 34 and the height sensor electronics module 36 define a height sensing system. The height sensing system can advantageously be a capacitive height sense system known to those skilled in the relevant art.

The slide mechanism 22 generally comprises a linear slide 66 slidably coupled to a stationary fixture 70. The translation mechanism 30 mounts to the stationary fixture 70 at a mounting collar 72. An outer housing is coupled to the linear slide 66. The slide mechanism 66 includes a pair of linear bearings for riding along a pair of complementary shafts in the stationary fixture 70 during actuation (not shown). The height signal is communicated through a fourth wire 80 extending between the housing 48 and the linear slide 66. From the linear slide 66, the signal is communicated to the height sensor electronics module 36 through the first wire 34 (FIG. 1).

The mounting flange 52 is coupled between the robot arm 16 and the stationary fixture 70. The mounting flange 52 is connected to the robot arm 16 with fasteners (not shown) disposed through mounting passages 84 arranged on a lip 86 of the mounting flange 52. The mounting flange 52 does not move with respect to the stationary fixture 70 during operation and is suitably coupled to the stationary fixture 70 by fasteners (not shown). The configuration of the mounting flange 52 is exemplary and may be varied with use of different robot and robot arm arrangements.

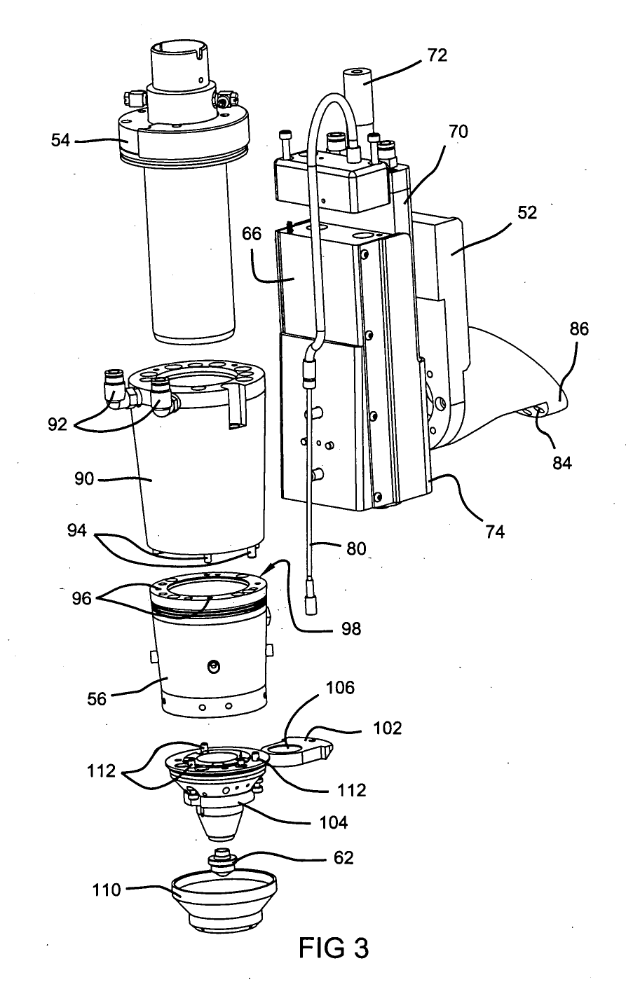

Turning now to FIG. 3, the components associated with the laser housing 48 are shown in exploded view and will be described in greater detail. The fiber recollimation optical component 54 is received by a fiber adapter block 90. The fiber adapter block 90 provides an attachment point at fittings 92 for receiving incoming assist gases required for a processing event. A plurality of locating pins 94 extend on a lower face of the fiber adapter block 90 and are accepted by receiving bores 96 arranged around an upper rim 98 of the lens holder 56.

The tip assembly 60 (FIG. 2) includes a fixed window holder 102 and a tip retainer 104. The fixed window holder 102 includes a window 106 which allows the laser beam to pass through. The fixed window holder 102 also seals a chamber of pressurized gas in the tip retainer 104. The tip retainer 104 operates to deliver the assist gas fed through the fittings 92 coaxially with the laser beam. In addition, the tip assembly 60 is constructed to isolate the capacitive height sensor signal from ground and the remaining laser assembly components. The tip 62 is attached to a distal end of the tip retainer 104. A protective collar 110 shields holds the tip retainer 104 from debris generated during processing. A series of screws 112 are received in complementary bores (not shown) on a lower face of the lens holder 56.

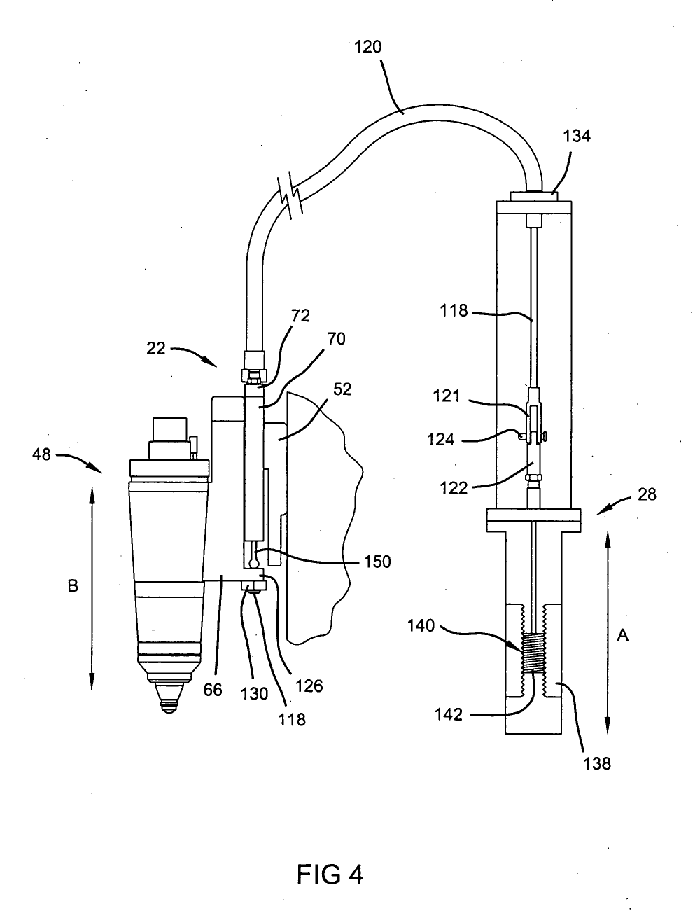

With reference to FIG. 4, the operation of the translation mechanism 30 and the actuation mechanism 28 will be described. The translation mechanism 30 generally includes a flexible cable or cable control 118. The cable control 118 is generally comprised of a flexible inner core having an outer conduit 120. The cable control 118 connects on a first end to an attachment fork 121 which is coupled to an actuating shaft 122 through a pin 124. An opposite end of the cable control 118 is coupled to a lower flange 126 of the linear slide 66 with a fastener 130. The conduit 120 is attached to an end surface 134 of the actuation mechanism 28 on a first end and coupled to the mounting collar 72 of the stationary fixture 70 on an opposite end.

The actuation mechanism 28 is illustrated as a linear actuator in the form of a roller screw mechanism. In general, the actuation mechanism 28 converts rotary torque into linear motion. Those skilled in the art will appreciate that other actuation mechanisms may be employed for actuating the linear slide 66 of the laser processing head assembly 12. For example a guide rail and ball screw arrangement, a belt drive, an electric motor and servo controlled air or hydraulic cylinder configuration and other arrangements may similarly be employed. In addition, while the actuation mechanism 28 is shown located on an upper surface of the robot 20, other locations remotely located from the laser processing head assembly 12 may similarly be used. For example, the actuation mechanism 28 may be located on another portion of the robot arm 16 or fixed to another structure entirely.

The actuation mechanism 28 includes a motor 138 and a roller screw mechanism 140. The roller screw mechanism 140 includes a plurality of threaded rollers 142 assembled in a planetary arrangement around threads arranged on the actuating shaft 122. The motor 138 produces a rotary motion which causes the rollers 142 to advance linearly (arrow A) within the cylindrical structure of the motor 138 thereby converting rotational movement of the motor into linear movement of the actuating shaft 122. Linear movement of the actuating shaft 122 causes the cable control 118 to slidably translate within the conduit 120. Because the cable control 118 is attached to the linear slide 66 at the lower flange 126, movement of the cable control 118 causes resulting movement of the housing 48 (arrow B). The implementation of the translation mechanism 30 allows the actuation mechanism 28 and consequently the motor drive electronics module 42 to be physically located at some distance away from the laser processing area. As a result, these components are more protected from the harsh environment of the immediate laser processing area. Another benefit to locating the actuation mechanism 28 in a remote location relative to the laser processing area is that motor and motor drive selection is no longer limited by size or packaging constraints.

For illustrative purposes, the housing 74 (FIG. 3) is shown removed from the linear slide 66 in FIG. 4. An air cylinder 150 cooperates with the slide mechanism 22 to impose a downward force (as viewed from FIG. 4) onto the linear slide 66. More specifically, the air cylinder 150 imposes a force onto the lower flange 126 to move the linear slide 66 downward relative to the stationary fixture 70. The air cylinder 150 provides a constant force on the cable control 118 away from the actuation mechanism 28 to insure that the cable control 118 is always under tension. It is appreciated that other mechanisms may be employed to encourage tension in the cable control 118.

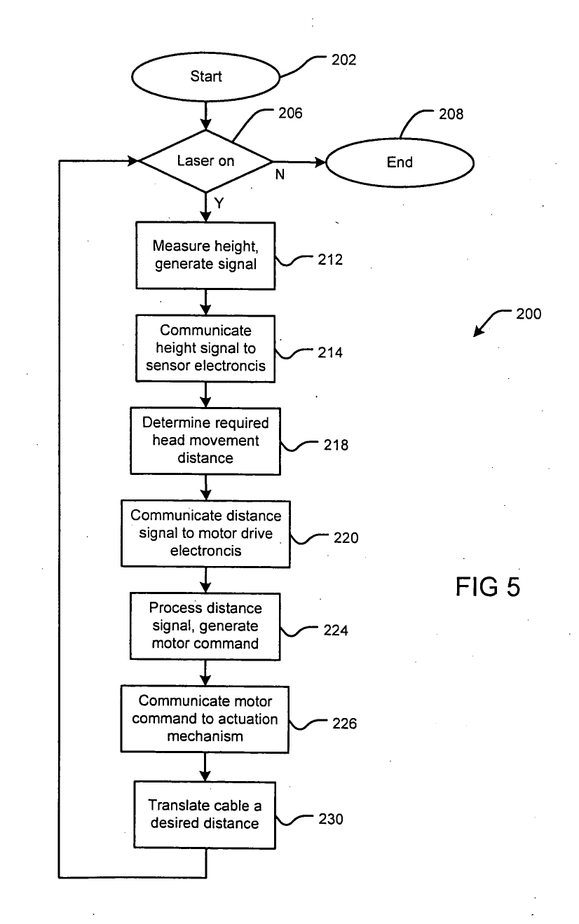

With reference to FIG. 5, steps for remotely actuating the laser processing head assembly are shown generally at 200. Control begins in step 202. In step 206, control determines whether the laser assembly is on. If the system is not on, control ends in step 208. If the system is on, a height measurement is performed by the height sensor electronics module 36 in connection with the tip 62. In step 214, the height sensor electronics module 36 determines the distance between the tip 62 and the work-piece 26. In step 218, a required laser processing head movement distance is determined. In step 220, the distance signal is communicated through the second wire 40 to the motor drive electronics module 42. In step 224, the distance signal is processed and a motor command is generated. In step 226, the motor command is communicated through the third wire 44 to the actuation mechanism 28. In step 230, the cable control 118 is translated a desired distance. Control then loops to step 206.

Those skilled in the art can now appreciate from the foregoing description that the broad teachings of the present invention can be implemented in a variety of forms. For example, the robot 20 is preferably a CNC robot for moving the laser processing head in a predetermined manner but may comprise other robot implementations or machinery. In addition, while the signal communication between the laser processing head assembly, the sensor electronics and the motor drive electronics has been described in relation to transmitting signals through first and second wires, it is contemplated that a wireless signal may be communicated between respective components. In this regard, the sensor electronics and motor drive electronics may similarly be located remotely from the laser head assembly without the requirement of physical attachment by wire. Therefore, while this invention has been described in connection with particular examples thereof, the true scope of the invention should not be so limited since other modifications will become apparent to the skilled practitioner upon a study of the drawings, the specification and the following claims.

What is claimed is:

1. A method for laser processing a work-piece comprising:
providing a laser processing head wherein the laser processing head is coupled to a control system for directing movement of said laser processing head over the work-piece wherein the laser processing head further comprises a sensor for measuring the distance between said laser processing head and the work-piece;
measuring the distance between said sensor and the work-piece;
generating movement of an actuation mechanism located remotely from said sensor based on said measured distance; and
translating said movement of said actuation mechanism into linear motion of said laser processing head toward and away from said work-piece.

2. The method of claim 1 further comprising:
communicating said measured distance from said sensor to a height sensing electronics module; and
communicating a signal based on said measured distance from said height sensing electronics module to said actuation mechanism.

3. The method of claim 1 wherein translating said movement of said actuation mechanism comprises:
imposing movement from said actuation mechanism onto a translation mechanism interconnected between said actuation mechanism and said laser processing head; and
linearly actuating said laser processing head based on movement communicated through said translation mechanism.

4. The method of claim 3 wherein linearly actuating said laser processing head comprises:
imposing a force onto said laser head thereby imposing relative linear motion of said laser processing head with respect to a robot arm supporting said laser processing head.

5. The method of claim 3 wherein linearly actuating said laser processing head includes imposing a force on a cable control connected between said actuation mechanism and said laser processing head.

6. A laser processing head remote control method for laser processing a work-piece, comprising:
electronically measuring a distance between the work-piece and the laser processing head;
electronically determining the required distance between the work-piece and the laser processing head;
communicating an adjustment to a motor drive that is remotely located and not connected to the laser processing head;
actuating by the motor drive a cable in sliding communication with the laser processing head to adjust the distance between the laser processing head and the work-piece; and
repeating the above steps.

7. The method of claim 6 further comprising:
translating movement of an actuation mechanism actuated by the motor drive into linear movement of the laser processing head.

8. The method of claim 6 further comprising:
linearly actuating the laser processing head in response to actuating the cable.

9. The method of claim 6 further comprising:
converting rotative movement of an actuation mechanism into linear movement of the cable.

10. The method of claim 6 further comprising:
rotating the cable;
converting the rotation of the cable into linear movement of the laser processing head.

11. A remote controlled laser processing method for processing a work-piece with a laser processing head, the method comprising:
sensing with a capacitive height sensing system the distance between the work-piece and the laser processing head wherein a capacitive height sensor is disposed in the laser processing head and substantially all of the electronics for the capacitive height sensing system are remote and not connected to the laser processing head;
operating a motor drive by the capacitive height sensing system wherein the motor drive is remote and not connected to the laser processing head;
actuating a translation mechanism by the motor drive wherein the translation mechanism is remote and not connected to the laser processing head; and
linearly actuating the laser processing head by a cable connected on one end to the translation mechanism and in sliding communication with the laser processing head on the other end.
